(19) United States
(12) Patent Application Publication
(10) Pub. No.: US 2002/0123408 A1
(43) Pub. Date: Sep. 5, 2002

(54) Starter

(76) Inventors: Gerhard Koelle, Wiernsheim (DE); Peter Ahner, Boeblingen (DE); Manfred Ackermann, Oppenweiller (DE)

Correspondence Address: Striker Striker & Stenby, 103 East Neck Road, Huntington, NY, 11743, US

(21) Appl. No.: 10/030,768

(22) PCT Filed: Feb. 22, 2001
(86) PCT No.: PCT/DE01/00667

(30) Foreign Application Priority Data
Feb. 22, 2000 (DE) 100 07 959.8

(51) Int. Cl. F02N 15/00

(52) U.S. Cl. 475/153

(57) ABSTRACT

The invention concerns a starter (5) for an internal combustion engine (ICE), whereby the starter (S) comprises a drive (D).

It is provided that the drive (D) comprises at least one first drive gear ratio (i₁) and a second drive gear ratio (i₂) that is lower than the first drive gear ratio (i₁), that the first drive gear ratio (i₁) is used at least in a first starting phase of a starting procedure, and that, at least when a specified ambient temperature is exceeded, the second drive gear ratio (i₂) is used in a second starting phase that occurs after the first starting phase.

The invention concerns a starter of an internal combustion engine having the features named in the preamble of Claim 1.

### RELATED ART

Starters of the type according to the general class are known. The drive of such starters can be represented by a meshing drive, for example, that transfers the pushing motions of the starter solenoid and the rotary motion of the electric starter motor to the pinion in suitable fashion.

The electric motors used to start internal combustion engines are direct-current motors, alternating-current motors, or three-phase motors. The direct-current series-wound motor is particularly suited for use as a starter motor, because it develops the high initial torque required to overcome the starting resistances and accelerate the material mass of the internal combustion engine.

The torque of the starter is transferred to the flywheel on the crankshaft of the internal combustion engine primarily by way of a pinion and a ring gear. In isolated cases, however, V-belts, toothed belts, chains, drives or direction transmission to the crankshaft are selected as well. Due to the high gear ratio between the starter pinion and the ring gear of the engine flywheel, the pinion starter can be designed so that torque is high at low speeds.

The exhaust emissions value during the starting procedure is comparably high regardless of the particular type of starter type used, because the combustion process is not optimal below the idling speed of the internal combustion engine.

To solve this problem, it is already known to accelerate the internal combustion engine during the starting procedure to a speed that is close to the idling speed of the internal combustion engine. The starting torques and speeds required for this can only be achieved using high starting power, because the characteristic line must cover high starting torques at the beginning of the starting procedure as well as high speeds to support the revving-up of the engine. In order to provide these starting torques and speeds, it was previously proposed to superimpose two conventional starters—one with a reducing gear and one without—in such a fashion that high torques as well as high speeds are covered. The disadvantage of this is the high hardware expense of two starters and an additional control expense to prevent the superimposition of the two short-circuit currents in the vehicle electrical system.

### ADVANTAGES OF THE INVENTION

Due to the fact that the drive comprises at least one first drive gear ratio and a second drive gear ratio that is lower than the first drive gear ratio, that the first drive gear ratio is used at least in a first starting phase of a starting procedure, and that, at least when a specified ambient temperature is exceeded, the second drive gear ratio is used in a second starting phase that occurs after the first starting phase, it is possible to rev up the internal combustion engine using a single starter to a speed that is close to the idling speed of the internal combustion engine before fuel is injected and ignited in the cylinder.

Since practically no combustion takes place below idling speed, the starter according to the invention makes a marked reduction of the exhaust emissions value occurring during the starting procedure possible at a cost that is minimal compared to solutions using two starters.

At extremely low ambient temperatures lying below the specified ambient temperature of less than −10° C., for example, it can be advantageous to operate the starter only with the first drive gear ratio, however, because markedly higher driving torques are then required overall.

In the case presented below, however, it will be assumed that the specified ambient temperature is exceeded, i.e., that the second drive gear ratio is used.

The solution according to the invention with change-over of the gear ratio during the starting procedure functions using markedly reduced starting power, because the power is adjusted by the change in gear ratio in the course of the starting procedure.

The first starting phase preferably begins at the beginning of the starting procedure. In this case, due to the high initial gear ratio, the first compression strokes are carried out with good acceleration and high torque. As a result, the higher load moment at the beginning of the starting procedure that is generated, among other things, by the pneumatic spring moments and additional moment losses of the internal combustion engine, can be overcome, whereby an additional smoothening effect occurs due to the higher moments of inertia.

If the second starting phase having the lower gear ratio directly follows the first starting phase, then, when this lower gear ratio is changed over to, a rapid further acceleration of the crankshaft to the stationary crankshaft speed increased in accordance with the reduced gear ratio is achieved as a result of the overall inertia, which is then reduced.

When the lower gear ratio is changed over to, a torque thrust first occurs due to the deceleration of the rotating mass of the starter. Due to the overall inertia, which is then reduced, the rapid further acceleration of the crankshaft to the stationary crankshaft speed increased in accordance with the reduced gear ratio, as mentioned above, occurs.

Overall, full support for the revving-up of the engine is achieved in this fashion. Depending on the layout of the drive gear ratios, the driving torque transferred to the crankshaft can be more than doubled at higher speeds as compared to traditional starters, for example. Compared to the drive having the lower drive gear ratio, drops in speed during the compression phase can be reduced considerably. The starter according to the invention can therefore be used in a wide starting temperature range, and markedly greater starting dynamics are achieved within the frequently-occurring starting temperature range.

The change-over from the first drive gear ratio to the second drive gear ratio preferably takes place in controlled or regulated fashion.

In this context, it is feasible that the change-over from the first drive gear ratio to the second drive gear ratio take place in time-controlled fashion, depending on special properties of the internal combustion engine.

Furthermore, the change-over from the first drive gear ratio to the second drive gear ratio can take place in speed-sensitive fashion.

In this case, it is particularly advantageous if the change-over from the first drive gear ratio to the second drive gear ratio takes place at the speed at which the torques at the crankshaft are at least nearly equivalent for the first drive gear ratio and the second drive gear ratio.

The change-over from the first drive gear ratio to the second drive gear ratio can also take place when the torque transferred at the drive becomes negative, i.e., when a driving torque is transferred from the internal combustion engine to the starter at the drive. Self-control would be involved in this case.

The change-over from the first drive gear ratio to the second drive gear ratio can take place by way of a planetary gear, for example. In this case, the input of the planetary gear can be at the sun gear, and the output can be at the planetary carrier. The internally toothed ring gear of the planetary gear can be held when the first drive gear ratio is used, and it can be connected to the sun gear side by way of a coupling when the second drive gear ratio is used. A coupling between internally toothed ring gear and planetary carrier, or between planetary carrier and sun gear, is also feasible to implement the second drive gear ratio.

Moreover, the starter according to the invention can be present in the form of a starter-generator that remains connected to the crankshaft while the internal combustion engine operates and supplies the vehicle electrical system with energy.

For the case in which the starting procedure is terminated before the internal combustion engine was started, it can be provided that a change-over to the first drive gear ratio take place automatically, provided it is not already being used at the moment when the starting procedure is terminated.

### DIAGRAMS

The invention is described in greater detail below using the associated diagrams.

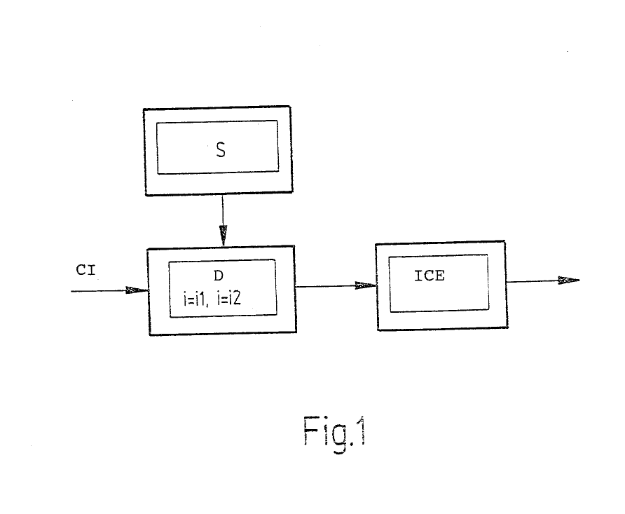

FIG. 1 shows a schematic diagram of an embodiment of the present invention.

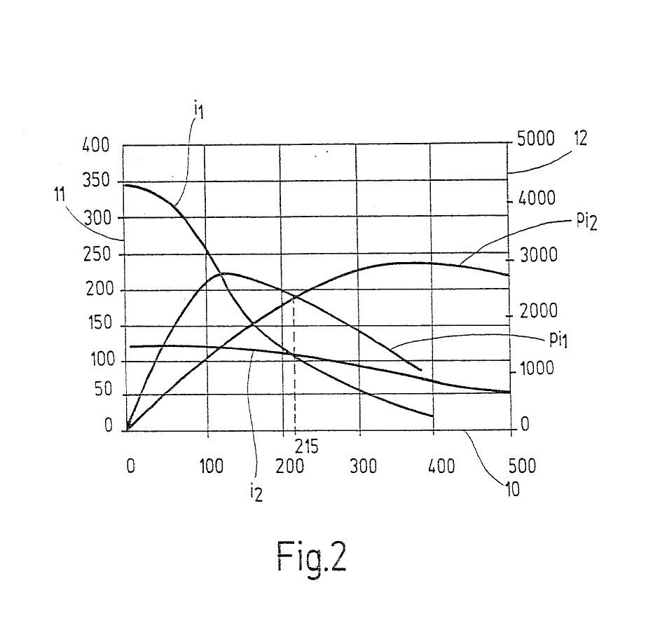

FIG. 2 shows the course of the torque transferred to the crankshaft, the crankshaft speed and the power in a case in which the first drive gear ratio is equal to nine and the second drive gear ratio is equal to three.

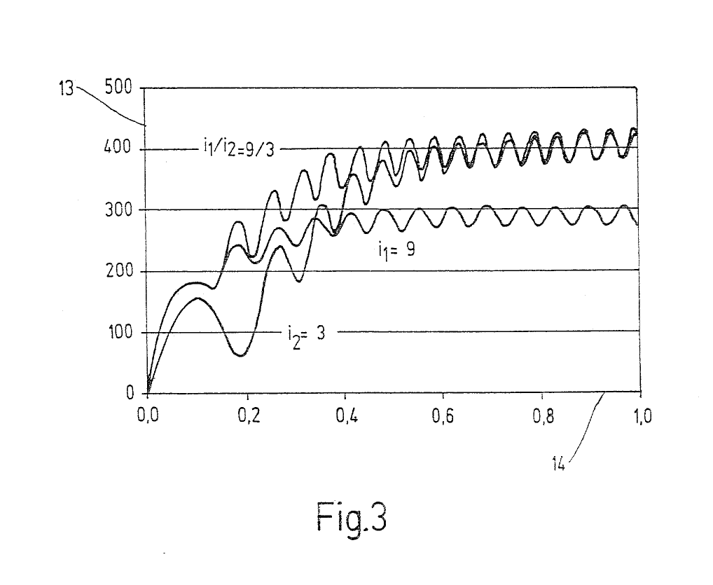

FIG. 3 shows the courses of the speeds occurring during a starting procedure as a function of time, with an exclusive use of a first drive gear ratio that is equal to nine, with an exclusive use of a second drive gear ratio that is equal to three, and with a change-over according to the invention from the named first drive gear ratio to the named second drive gear ratio.

### DESCRIPTION OF THE EMBODIMENT

In the schematic diagram of an embodiment of the present invention shown in FIG. 1, the starter is labelled “S”, and the associated drive is labelled “D”. The drive shaft of the electric starter motor can be connected in non-positive fashion with the drive D, which, in turn, can be connected in non-positive fashion with the internal combustion engine ICE, e.g., by way of an engaging drive part of the drive D.

The drive D comprises a control input CI at which a control signal can be applied that can trigger a change-over from the first drive stage i₁ to the second drive stage i₂ and vice versa, whereby it is also feasible, of course, that more than two drive stages are provided.

The starter S comprises only one single electric machine, and, as described above, the change-over from the first drive gear ratio i₁ to the second drive gear ratio i₂ can take place in time-controlled and/or speed-sensitive fashion, or it can be controlled or regulated in any other fashion.

Although the emission behavior is not improved compared to known starters, it is feasible that only the first drive gear ratio i₁ is used below a specified ambient temperature in order to generate the high driving torque required at extremely low ambient temperatures. In this case, the control signal applied at the control input CI would also depend on the ambient temperature.

The mode of operation when only one drive gear ratio is used represents a special case only, however, which is to be covered by the present invention.

The higher first drive gear ratio i₁ is preferably optimized with regard for the cold-start limit temperature. The lower second drive gear ratio i₂ is preferably optimized for the generator gear ratio at higher crankshaft speeds and for support for the revving-up of the engine during starting, and for revving up the engine to a speed that lies in the range of the idling speed of the internal combustion engine ICE. The optimization thereby preferably takes place for an ambient temperature range that is above 20° C.

In FIG. 2, the torque of the crankshaft in Nm is plotted on the left vertical axis 11, power in W is plotted on the right vertical axis 12, and crankshaft speed is plotted in I/min on the horizontal axis 10.

FIG. 2 shows the course of the torque transferred to the crankshaft, the crankshaft speed, and the power for a case in which the first drive gear ratio is i₁=9, and the second drive gear ratio is i₂=3.

In the case shown in FIG. 2, the change-over from the first drive gear ratio i₁ to the second drive gear ratio i₂ takes place in speed-sensitive fashion at the speed at which the torque achieved with the first drive gear ratio i₁ is equal to the torque achieved at this crankshaft speed with the second drive gear ratio i₂, or is exceeded by it.

In the case depicted in FIG. 2, the change-over from the first drive gear ratio i₁=9 to the second drive gear ratio i₂=3 takes place at a crankshaft speed of approximately 215 revolutions per minute.

The characteristic power lines Pi₁ and Pi₂ also shown in FIG. 2 indicate that the power is approximately doubled in a speed range of between 200 and 500 revolutions per minute.

In FIG. 3, speed is plotted in I/min on the vertical axis 13, and time is plotted in sec on the horizontal axis 14.

FIG. 3 shows the courses of the speed occurring during a starting procedure as a function of time, with an exclusive use of a first drive gear ratio i₁=9, with an exclusive use of a second drive gear ratio i₂=3, and with a change-over according to the invention from the named first drive gear ratio to the named second drive gear ratio i=9/3.

The courses of the curves shown in FIG. 2 apply for the starting procedure of a V6 internal combustion engine, i.e., for an internal combustion engine having six cylinders, with three cylinders lying in two rows each and the rows arranged in the shape of a V. Moreover, the curves shown in FIG. 2 apply for an ambient temperature of 20° C.

The course of the curve indicates that, in the case of the exclusive use of the first drive gear ratio i₁=9 for the selected starting conditions, only moderate dynamics and a limited stationary speed of approximately 280 revolutions per minute are achieved.

In contrast, in the case of the exclusive use of the second drive gear ratio of i₂=3, a high stationary speed of approximately 400 revolutions per minute is achieved. At this drive gear ratio i₂, only a moderate initial acceleration is achieved, however.

Moreover, the starting procedure becomes very unreliable in the range of the first compression, which occurs at approximately 0.18 seconds in the diagram, because the speed is only approximately 60 revolutions per minute at this point in time. An internal combustion engine ICE having a somewhat higher drag torque could no longer be started under these conditions, or it could at least not be started reliably.

The curve labelled i=9/3 shows the starting procedure using the starter according to the invention.

One can see that, by changing over from the first drive gear ratio i₁=9 used in the first starting phase to the second drive gear ratio i₂=3 used in the second starting phase, the highest starting dynamics overall are achieved. Both the initial torque and the stationary speed are optimal.

Although the invention was described above based on an embodiment in which the drive mechanism comprises two drive gear ratios, the invention is in no way limited to this number of drive gear ratios. More than two drive gear ratios can be used, depending on the design of the internal combustion engine ICE.

The change-over between the drive gear ratios can be made dependent on further ambient conditions or engine parameters in such a fashion that all available drive gear ratios are not used in every case.

In particular, when the starter S is a starter-generator, a drive gear ratio dedicated solely to the operation of the generator can be provided.

1. Starter (S) for an internal combustion engine (ICE), whereby the starter (S) comprises a drive (D), characterized in that the drive (D) comprises at least one first drive gear ratio (i₁) and a second drive gear ratio (i₂) that is lower than the first drive gear ratio (i₁), that the first drive gear ratio (i₁) is used at least in a first starting phase of a starting procedure, and that, at least when a specified ambient temperature is exceeded, the second drive gear ratio (i₂) is used in a second starting phase that occurs after the first starting phase.

2. Starter (S) according to claim 1, characterized in that the first starting phase begins at the beginning of the starting procedure.

3. Starter (S) according to one of the preceding claims, characterized in that the second starting phase follows the first starting phase.

4. Starter (S) according to one of the preceding claims, characterized in that the change-over from the first drive gear ratio (i₁) to the second drive gear ratio (i₂) takes place in controlled or regulated fashion.

5. Starter (S) according to one of the preceding claims, characterized in that the change-over from the first drive gear ratio (i₁) to the second drive gear ratio (i₂) takes place in time-controlled fashion.

6. Starter (S) according to one of the preceding claims, characterized in that the change-over from the first drive gear ratio (i₁) to the second drive gear ratio (i₂) takes place in speed-sensitive fashion.

7. Starter (S) according to one of the preceding claims, characterized in that the change-over from the first drive gear ratio (i₁) to the second drive gear ratio (i₂) takes place at the speed at which the torques at the crankshaft are at least nearly equivalent for the first drive gear ratio (i₁) and the second drive gear ratio (i₂).

8. Starter (S) according to one of the preceding claims, characterized in that the change-over from the first drive gear ratio (i₁) to the second drive gear ratio (i₂) takes place when the torque transferred at the drive (D) becomes negative.

9. Starter (S) according to one of the preceding claims, characterized in that the change-over from the first drive gear ratio (i₁) to the second drive gear ratio (i₂) takes place by way of a planetary gear.

10. Starter (S) according to one of the preceding claims, characterized in that the input of the planetary gear is at the sun gear, and the output is at the planet carrier.

11. Starter (S) according to one of the preceding claims, characterized in that the internally toothed ring gear of the planetary gear is held when the first drive gear ratio (i₁) is used, and that the internally toothed ring gear of the planetary gear is connected to the sun gear side by way of a coupling when the second drive gear ratio (i₂) is used.

12. Starter (S) according to one of the preceding claims, characterized in that it is a starter-generator.

13. Starter (S) according to one of the preceding claims, characterized in that, when the starting procedure is terminated, a change-over to the first drive gear ratio (i₁) takes place automatically, provided it is not already being used at the time the starting procedure is terminated.
